(19) United States
(12) Patent Application Publication
(10) Pub. No.: US 2017/0020283 A1
(43) Pub. Date: Jan. 26, 2017

(54) STORAGE AND HANDLING RACK FOR MULTIPLE EXCAVATOR BUCKETS

(71) Applicant: Craig Richard Hokanson, Clearfield, UT (US)

(72) Inventor: Craig Richard Hokanson, Clearfield, UT (US)

(21) Appl. No.: 15/049,005

(22) Filed: Feb. 19, 2016

Related U.S. Application Data
(60) Provisional application No. 62/118,116, filed on Feb. 19, 2015.

(51) Int. Cl. A47B 81/00; B65G 1/02; A47B 47/00

(52) U.S. Cl. CPC A47B 81/00; A47B 47/00; B65G 1/02

(57) ABSTRACT

A storage and handling rack is disclosed for multiple excavator buckets, adapted to form a stable, single or multi-tiered structure for securing buckets. The stored buckets can be easily accessed by a forklift or excavator for adding or removing buckets from the rack. The rack secures the buckets in parallel sequence on load bearing shelves. The rack includes one or more tiers for retaining the buckets at different elevations. In this manner, variously sized and dimensioned buckets, which may have different functions, can be organized into designated tiers and sections of the rack. The rack is fabricated from multiple members that join together to support a plurality of buckets and minimize lateral movement, tensile forces, compressive forces, and instability for the rack.

### BACKGROUND OF THE INVENTION

Field of the Invention

This invention relates to an apparatus for storing excavator buckets, and more particularly related to an apparatus for storing a plurality of excavator buckets on one or more tiers.

Description of the Related Art

Excavator buckets and forklifts are well-known in the art. Typically, the forklift is a powered industrial truck used to lift and move materials short distances, while excavator buckets detachably affixed to track-hoes and other heavy equipment for excavating ground and substrates.

Buckets vary in weights and dimensions. Buckets are rated for different loads and applications. Buckets are heavy enough they cannot be moved by hand. Bucket owners occasionally stock a large variety of buckets, placed randomly on the ground, on pallets, and occasionally dangerously placed on pallet racks because operators lack a rack for organizing them. Buckets can be unstable when disconnected and difficult to install by hand safely. Buckets also are often left strewn over construction sites and there exists no means of storing buckets in a manner easily accessible by machinery making use of the buckets. These buckets rust and can freeze to the ground. This is a serious safety concern and may result in injuries including fingers, hands, hernias, back, hips, feet and other injuries.

When buckets are stored on a standard wooden pallets similar to those which are used in warehouse storage operations, the wood structure may fail resulting in the buckets tipping over sideways. The pallet cannot be moved with buckets placed on top safely, since there is no way to secure the buckets from tipping or moving.

Additionally the pallets do not provide any organizational structuring of the buckets. This can be problematic when trying to locate a desired bucket.

Even if regular planar shelving were to be introduced into the art for storing buckets, the buckets could not be accessed easily. There exists a need for racks or shelving which are accessible by excavators and forklifts. However, in some cases newer OSHA ANSI standards have limited the tilt angle of the forklift mast; in these cases the forklift may not be able to lean far enough forward to engage a bucket. A planar rack would make it difficult to align the machine in the proper vertical and horizontal positions to insert and remove the buckets and to connect or disconnect them from the forklift.

Nothing in the art properly addresses industry safety concerns such as the buckets tipping over, problems inherent with handling by hand, connection issues, and organization.

Racks or shelving is needed which stores and organizes buckets efficiently. Buckets can be very cumbersome and too heavy to be moved by hand. Current methods and apparati are not configured to safely organize and retain a plurality of various buckets, such that a bucket can be easily added and removed from the rack. It is therefore desirable that a bucket rack be provided that can be safely used by a forklift operator to organize excavator buckets, and increase safety for a forklift operator during addition and removal of the buckets from the rack.

Beneficially, such a rack would also allow water to drain out of the buckets, and allow the bucket to twist slightly into alignment.

### SUMMARY OF THE INVENTION

From the foregoing discussion, it should be apparent that a need exists for a storage and handling rack for multiple excavator buckets. Beneficially, such an apparatus would overcome many of the difficulties and safety concerns expressed, by providing a stable rack for storing a plurality of buckets in an organized manner and enable a safe selective, efficient access and connection to the buckets by a forklift or excavator.

The present invention has been developed in response to the problems and needs in the art that have not yet been fully solved by currently available apparati and methods. Accordingly, the present invention has been developed to provide a storage rack for storing excavator buckets, the storage rack comprising: a plurality of inclined shelves, including a top shelf and a lower shelf, each shelf affixed to a plurality of vertical posts, wherein each shelf is located over one another above a ground surface lower shelf; a plurality of vertical posts, each vertical post affixed to a plurality of shelves; a plurality of feet, each foot affixed to one of a bottom of a shelf and a riser; a plurality of risers, each riser affixed to incline the back of a shelf, the plurality of risers inclining the shelves.

Each shelf may define a recess for receiving one or more buckets. One or more buckets can be rested on each shelf. The storage rack may further comprise a bucket hook for detachably affixing to a forklift hitch adapter, the hook comprises a shaft and a concave member. The rack may be configured to be lifted and moved by a forklift. The shelves and vertical posts may be detachable from one another.

One or more of the vertical posts may comprise one or more of rods, bars, angles, square tubing, rectangular tubing, round tubing, oval tubing, channels, round pipe, plates, and I-beams.

The shelves and vertical posts may comprise one or more of metal, alloy, carbon steel, cast iron, aluminum, stainless steel, carbon fiber, fiberglass, resins, elastomeric materials, composites, GFRC, wood, and concrete.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an elevational frontal-side perspective view of a bucket storage rack in accordance with the present invention;

FIG. 1B is a top perspective view of a shelf of a bucket storage rack in accordance with the present invention;

FIG. 2 is an elevational frontal-side perspective view of a storage rack for storing buckets in accordance with the present invention;

FIG. 3 is a side perspective view of a storage rack for storing buckets in accordance with the present invention;

FIG. 4 is a front perspective view of a storage rack for storing buckets in accordance with the present invention;

FIG. 5 is an side perspective view of a storage rack for storing buckets in accordance with the present invention;

FIG. 6 is an elevational frontal-side perspective view of a storage rack for storing buckets with buckets in accordance with the present invention;

FIG. 7 is a front perspective view of a storage rack for storing buckets in accordance with the present invention;

FIG. 8 is a top perspective view of a shelf of a storage rack for storing buckets in accordance with the present invention;

FIG. 9 is a top perspective view of a shelf of a storage rack for storing buckets with buckets in accordance with the present invention;

FIG. 10A is a front-side perspective view of a bucket and bucket hook in accordance with the present invention;

FIG. 10B is a front perspective view of a bucket and bucket hook in accordance with the present invention;

FIG. 10C is a side perspective view of a bucket and bucket hook in accordance with the present invention; and

FIG. 11 is a side perspective view of a bucket hook in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

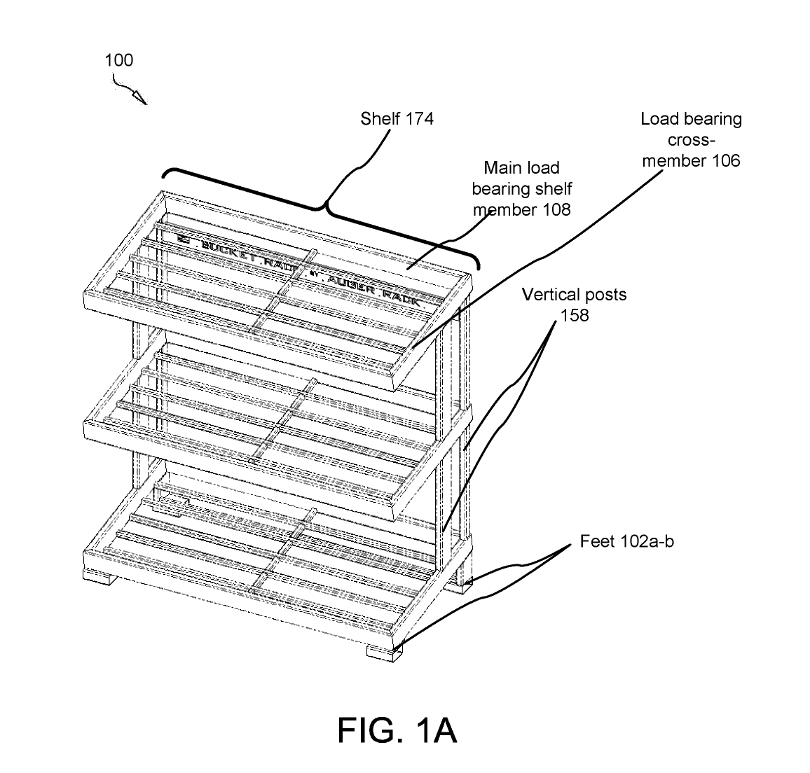

FIG. 1A is an elevational frontal-side perspective view of a excavator bucket storage rack 100 in accordance with the present invention. The rack 100 comprises feet 102a-b, a shelf 174, and vertical posts 158.

The rack 100 comprises multiple members, junctions, and organizational spacing configured to receive a plurality of buckets in an organized manner, and to stabilize the rack 100 against lateral movements, tensile forces, compressive forces, and instability while a forklift (not shown) racks or removes the buckets, or while the rack 100 is lifted for transport. The rack 100 is sufficiently rigid to support a plurality of buckets and withstand constant agitation from forklifts; and thus, may be manufactured from a rigid material, including, without limitation, steel, aluminum, magnesium, titanium, metal alloys, polymers, wood, carbon-fiber, and the like.

FIG. 1A illustrates a frontal perspective view of the rack 100 in accordance with the present invention. The rack 100 comprises at least four vertical posts 158a-d. In one embodiment, the posts 158a-f form generally rectangle or quadrilateral from an upper perspective view. Each post 158 extends in a substantially vertical direction from a ground surface. Those skilled in the art will recognize that the capacity of the forklift to raise and lower the buckets for racking and removal allows the posts 158 to have a height at least equivalent to the maximum lifting height of the forklift.

The rack 100 may include at least one load bearing shelf member 108 that extends horizontally between the vertical posts 158, or load bearing shelf members 108 on each side of the rack 100. The load bearing shelf members 108 and the vertical posts 158 may be welded or bolted together, overlay one another, or may be fastened through various fasteners at a junction. In some embodiments, the load bearing shelf members 108 and the vertical posts 158 are affixed to one another. The load bearing members 108 bear most of the direct weight from the excavator buckets.

In one embodiment, a pair of load bearing shelf members 108 position on opposite sides of the rack 100. The excavator buckets align in parallel sequence along the pair of load bearing shelf members 108. Furthermore, the multiple load bearing members 108 can be positioned at different elevations on the rack 100, forming multiple tiers of load bearing members 108 to support the buckets. In the shown embodiment, three tiers of parallel load bearing members 108 support three sets of buckets arranged in parallel. However, any number of tiers may be used.

FIG. 1B is an elevational frontal-side perspective view of a shelf of a storage rack 174 in accordance with the present invention. The shelf 174 comprises load bearing shelf members 108 and load bearingcross-members 176.

The load bearing shelf members 108 may interconnect vertical posts and each other to prevent upward and lateral movement toward the back of the rack by the buckets resting on the load bearing members 108.

The load bearing shelf members 108 can especially be beneficial to restrict torqueing forces on the shelf 174 when the forklift engages the rack 150. Additionally, the load bearing members 108 helps support the weight of the buckets, which can destabilize the rack 100.

A slot may form above the shelf by the load bearing shelf members 108. The slot is generally sized and dimensioned to receive the buckets for racking and removal.

As racking and removing of the buckets 202 progresses, the subsequent engagement between the forklift and the rack 100 tends to warp, contort, or strain the vertical posts 158 and the load bearing member 108 causing pressure to be exerted at the junctions. For this reason, the load bearing shelf members 108 and the vertical posts 158 may be reinforced with at least one stiffener.

All of the components of the rack 100 may be affixed together using welded joints, bolts, screws, magnets, pins, nails, gusset plates, and the like. These components may include, without limitation, bar stock, angle iron members, I-beams, and generally rectangular-shaped members having flanges. These components may include or define apertures drilled through the members and posts 106-118 for fastening them together. In one embodiment, the rack 100 is configured to fasten to a mounting structure (not shown). In other embodiments, the rack 100 is configured to be lifted and moved by the forklift.

The rack 100 provides a structurally stable and safe bucket rack that stores and secures a plurality of excavator buckets in an approximately parallel sequence and optionally at elevated tiers to enhance the safe organization of the excavator buckets and enable selective access and connection to the buckets by a forklift or excavator.

The rack 100 is a multi-tiered structure that is easily accessed by a forklift for inserting or removing a plurality of buckets. Additionally, the rack 100 may comprise one or more tiers for retaining the buckets at different elevations. In this manner, variously sized and dimensioned buckets, which may have different functions, can be organized into designated tiers and sections along the front side of the rack. This can be useful in industrial or rental settings where multiple excavator buckets or excavator sizes are utilized.

The rack 100 comprises multiple approximately vertical, horizontal, and optional angled members joined together in various directions to form strategic junctions. The members are comprised of different dimensions effective for stabilizing the rack against lateral movements, tensile forces, compressive forces, and instability while the buckerts are inserted or removed, or while the rack is lifted for relocating. These members may be formed from metallic or polymeric substances. Additionally, the rack 100 may be configured to receive the buckets directly onto horizontal members.

The load bearing shelf members 108 bear a substantial amount of weight from the buckets. In one embodiment, a pair of load bearing members 108 positioned on the front and back distribute the center of gravity between them depending on the buckets length and weight. The buckets may align in parallel sequence along the pair of load bearing members 108. Also, multiple load bearing members 108 can be positioned at different elevations along the rack 100, forming multiple tiers of load bearing members 108 to support the buckets.

Feet 102 may be attached or integrated into the rack 100, such that the feet 102 engage a ground surface and support the entire rack 100 and the plurality of buckets, distributing the load toward the furthest point(s) away, from the horizontal center. When placed on surfaces that have high and low spots, uneven cracks in pavement and concrete, the feet 102 of a specific height may be needed to increase the clearance of the rack 100 over the high points in the ground surface, also ensuring proper weight distribution. One or more feet 102 may be vertically adjusted to level the rack 100 relative to the surface. In this manner, the feet 102 are used to adjust the structure of the rack 100 to a parallel or level position relative to the surface.

The excavator bucket rack 100 may be comprised of structural components including, without limitation to, rod, bar, angle, square tube, rectangular tube, round tube, channel, pipe, I-beams, plate, and other structural components known in the art including bolts, nuts and other fasteners in some embodiments.

The excavator bucket rack may be comprised of many types of materials including, without limitation to, metals, carbon steel, cast iron, aluminum, stainless steel, alloys, carbon fiber, fiberglass, resins, plastics, composites, wood, and other structural materials known in the art.

In some embodiments the structural components of the rack 300 may comprise, or define, a number of apertures or holes drilled through the structural components for fastening the components together to the corner posts and other members.

In other embodiments the load bearing shelf members 108 to interlock incrementally at adjustable heights with the posts 158. By interlocking incrementally this embodiment also facilitates adjustability in the distance between the tiers of vertical excavator bucket storage. In other embodiments, the rack comprises incrementally-increasing in height apertures spaced apart to allowing bolts to be used to fasten the load bearing shelf members 108 to the posts 158. In other embodiments the structural components may be designed to be assembled from smaller parts allowing for more compact shipping, recognizing that these parts may also be assembled to an increased height where multiple vertical components are stacked or joined together to reach a desired height.

In some embodiments for lateral stability considering the overall height of the rack 100, the rack 100 is designed to be secured to a foundation by use of mounting brackets, feet with holes, anchor bolts, or other methods know in the art. In other embodiments the back or sides of the excavator bucket rack 100 may be secured to an existing structure giving it lateral stability.

However, in other embodiments, the rack 100 may be configured to be lifted and moved by a forklift. In some cases the rack 100 may be loaded with buckets, adding weight and changing the center of gravity. Lifting and moving the loaded rack 100 allows for snow removal, and access to the areas behind where the rack is located. Moving the loaded fork rack 100 may allow buckets to slide out of the rack 100 resulting in a dangerous situation for the fork lift operator. In this situation safety must be engineered into the rack to keep the forks from moving. Optional tie down points or other retaining methods know in the art of load securement should be attached if necessary.

In one embodiment tie down points for temporarily securing the excavator buckets from sliding while moving the loaded excavator bucket rack or in seismic areas of the world are attached on the shelf edges of the rack 100.

In some embodiments the opposing horizontal load bearing members 108 forming the same tier may be placed at different elevations causing the resting buckets to tilt backward or forwards aiding in the ideal angle for connecting the buckets with a bucket hook.

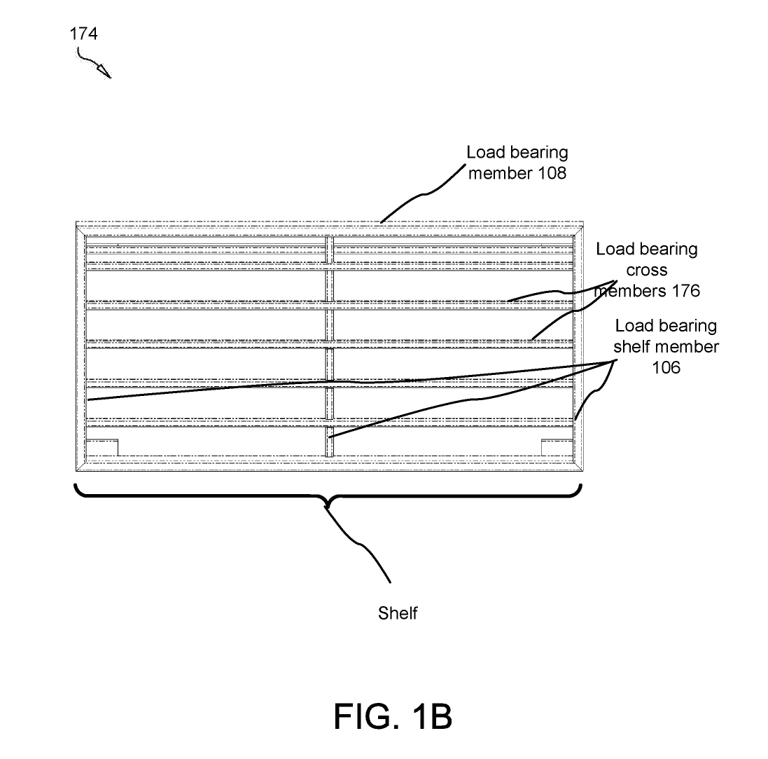

FIG. 2 is an elevational frontal-side perspective view of a storage rack for storing buckets 200 in accordance with the present invention. The storage rack 500 comprises a plurality of shelves 174, each having its own load bearing cross members 176 and load bearing shelf members 108 as support members. The shelf 174 holds one or more buckets, which are placed and removed from the shelf 174 with a forklift and bucket hook (see below).

The shelves 174 are spaced apart vertically along a longitudinal axis, in even spaced intervals in some embodiments though not in others. The shelves 174 are affixed to vertical posts 158. In the shown embodiment, the vertical posts 158 are all disposed toward the back of the shelves 174, leaving the forward majority of the each shelf 174 cantilevered over a ground surface or lower shelf 174, facilitating easier access with a forklift.

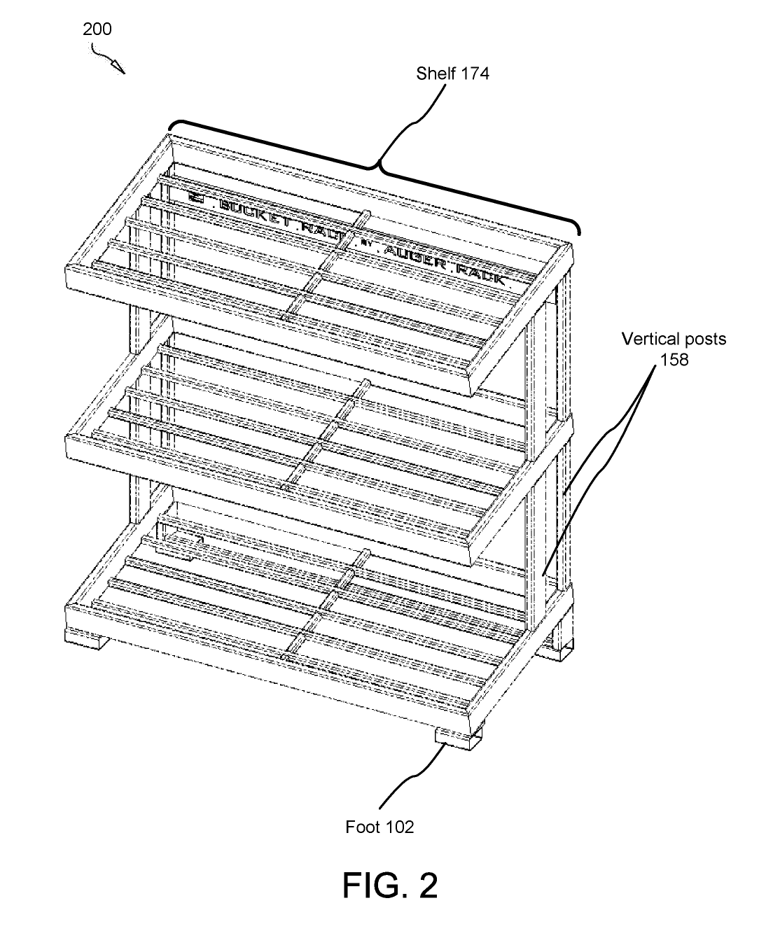

FIG. 3 is a side perspective view of a storage rack 300 for storing buckets in accordance with the present invention. As shown, the rack 300 comprises a riser 302 disposed underneath the backward end of the lower shelf 174. This riser inclines the shelf 174 between 1 degree and 50 degrees.

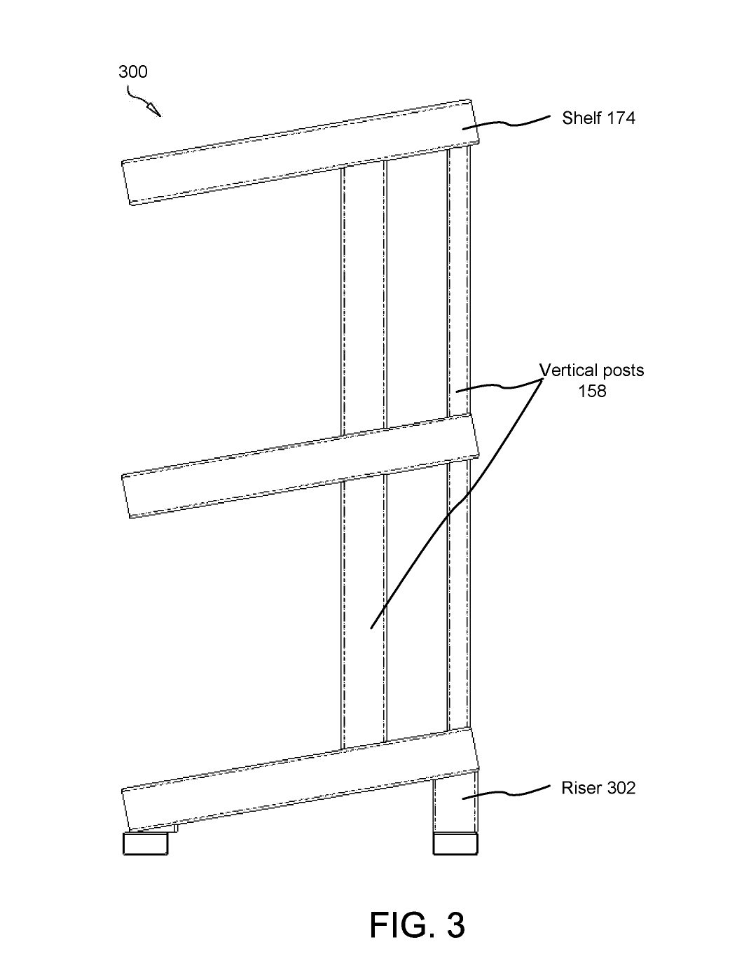

FIG. 4 is a front perspective view of a storage rack 400 for storing buckets in accordance with the present invention. The storage rack as shown comprises three shelves 174a-c, but in alternative embodiments may comprise anywhere from one shelf 174 to dozens.

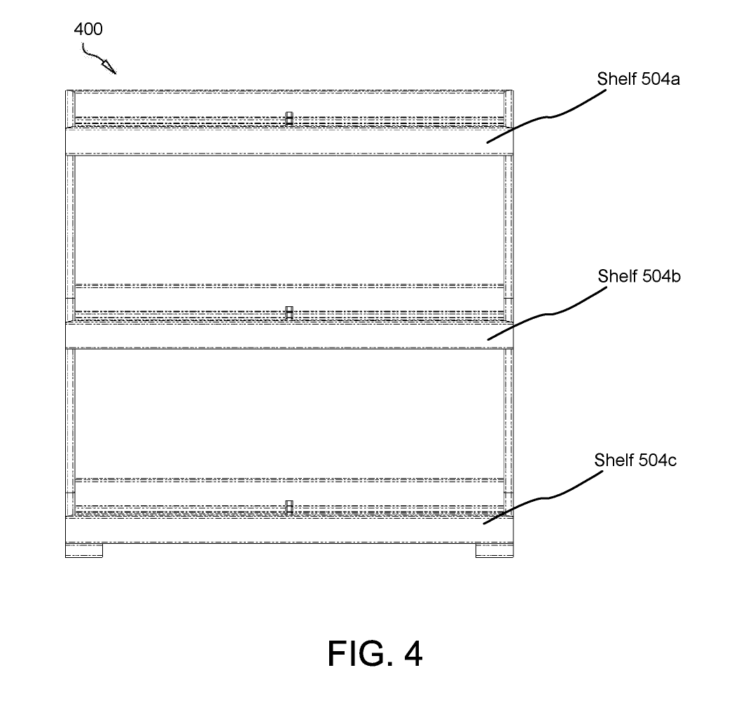

FIG. 5 is a side perspective view of a excavator bucket storage rack 500 for storing buckets with buckets in accordance with the present invention. As shown, a plurality of buckets 502 are received by rack 500 and rest on the shelves of the rack 500.

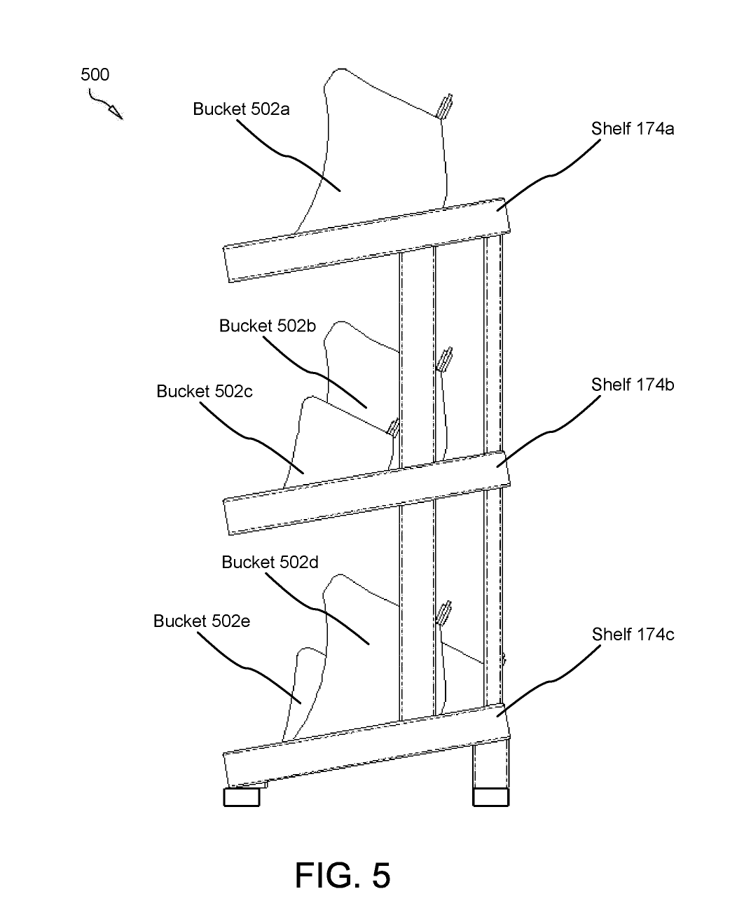

FIG. 6 is an elevational frontal-side perspective view of a storage rack 600 for storing buckets with buckets in accordance with the present invention. As shown, the buckets 502 may be stored in parallel on the inclined or declined shelves 174. Buckets 502 of different shapes, sizes and species are fitted into the rack 600 with a forklift.

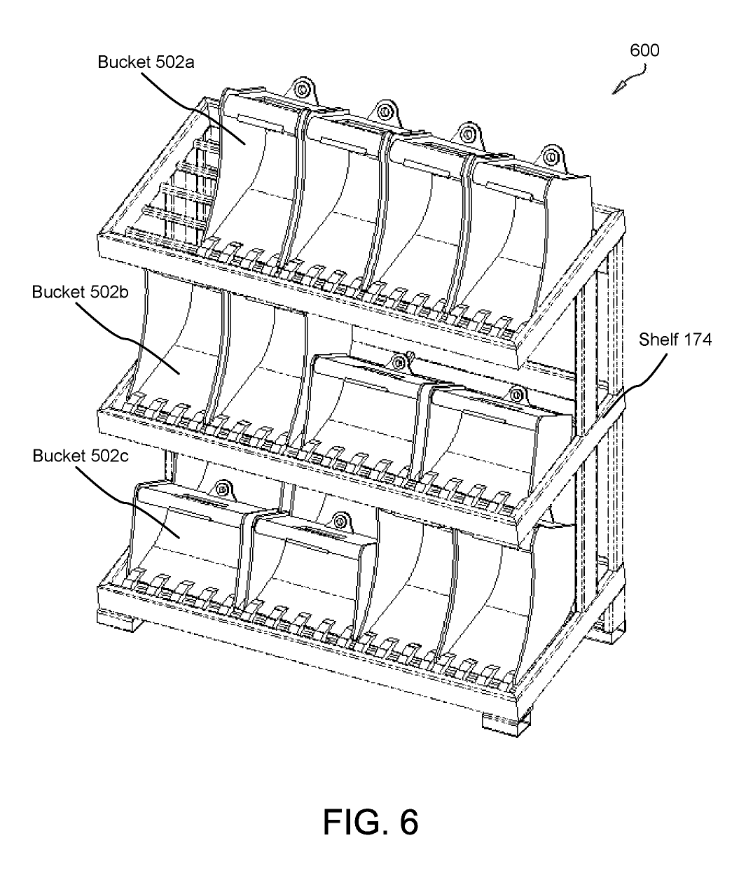

FIG. 7 is a front perspective view of a storage rack 700 for storing buckets 502 in accordance with the present invention. A plurality of different sized buckets 502 are stored.

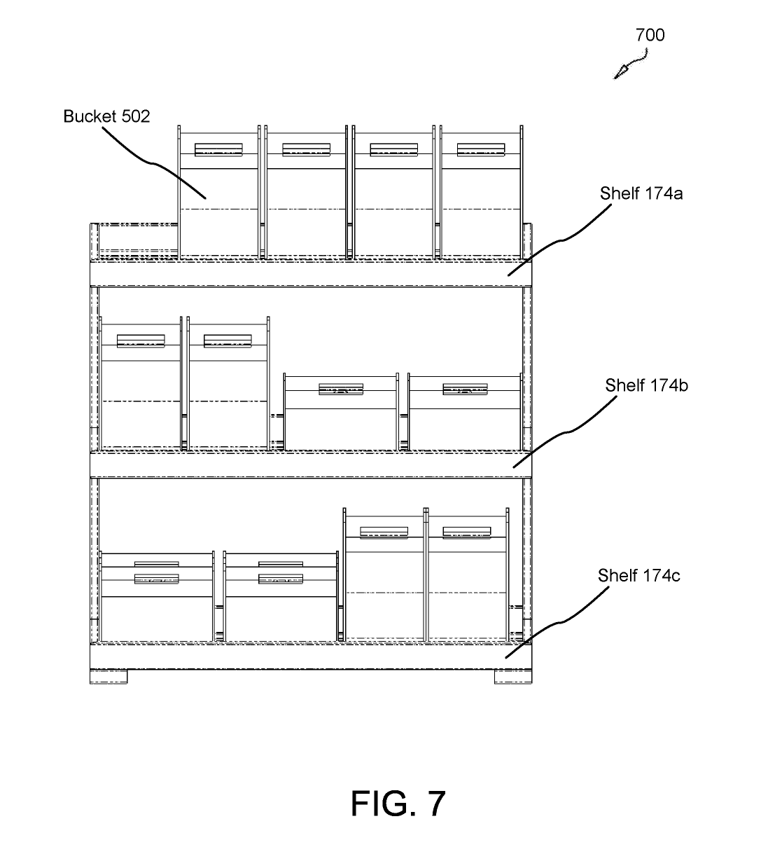

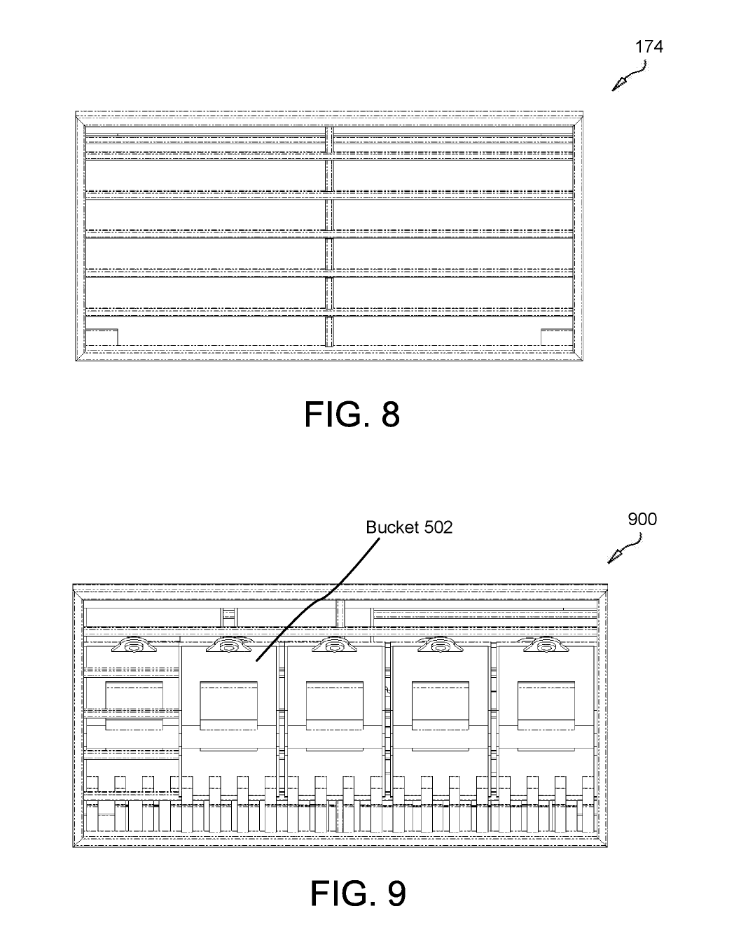

FIG. 8 is a top perspective view of a shelf 1100 of a storage rack for storing buckets in accordance with the present invention. The shelf 174 shown in this embodiments comprises a plurality of load bearing cross members 176 and load bearing shelf members 108 which traverse a side of the shelf 174.

The shelf 174, in the shown embodiment, defines a recess for receiving the buckets 502. This recess is defined in the shown embodiments by a lip circumscribing the load bearing cross members 176 and load bearing shelf members 108.

FIG. 8 is a top perspective view of a shelf 174 of a storage rack for storing buckets with buckets 502 in accordance with the present invention. The shelf 174 in the shown embodiment comprises four buckets 502 disposed side-by-side.

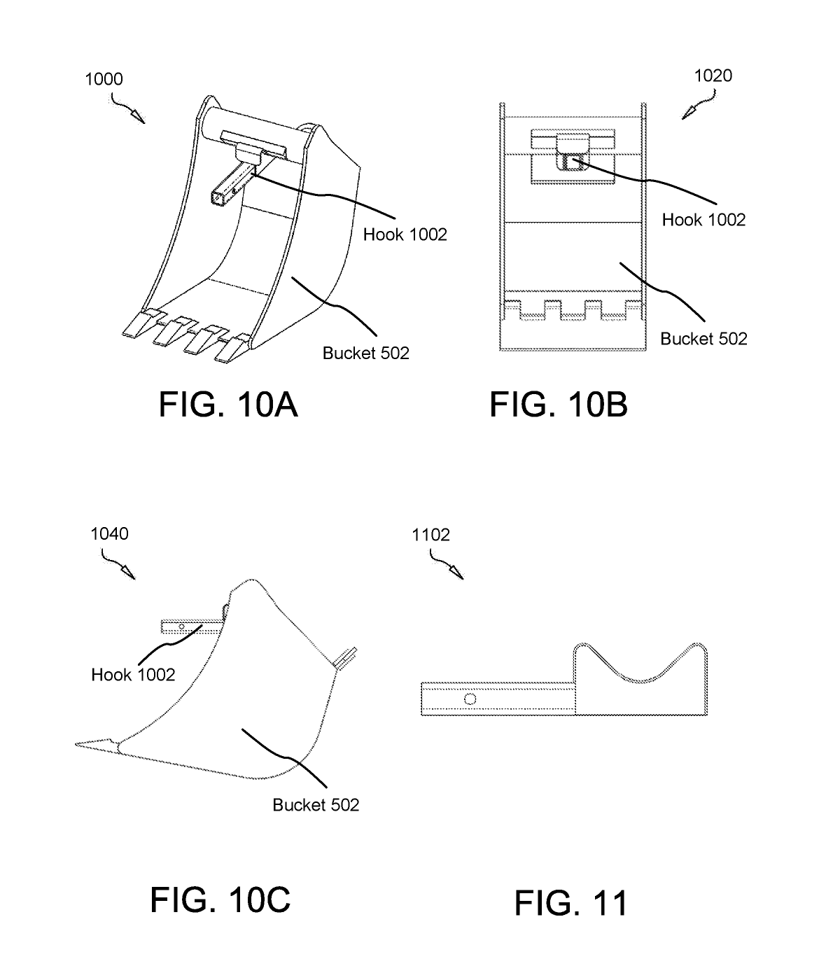

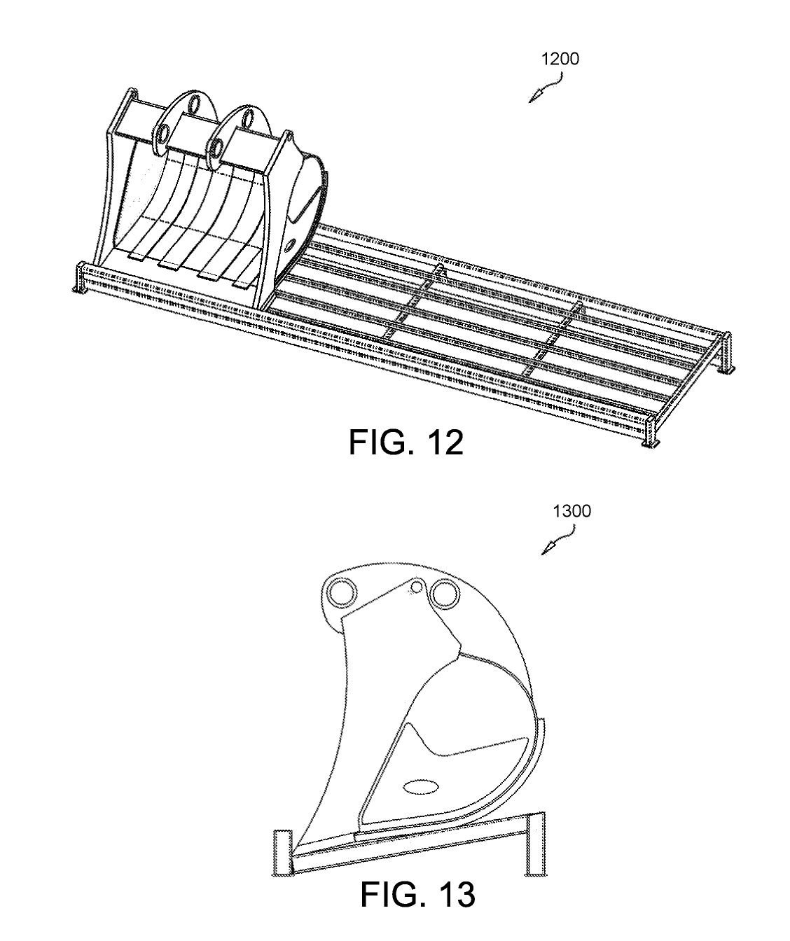

FIGS. 10A-13 C illustrate a various perspectives views of a bucket 502 and bucket hook in accordance with the present invention. The bucket hook 1002 is affixed to a forklift or forklift attachment and used to lift the bucket 502 in and out of the rack 600.

FIG. 14 is a side perspective view of a bucket hook in accordance with the present invention. The bucket hook 1002 comprises a shaft or bar affixed to a concave hook, bar, depression, or attachment for engaging a bucket 502.

In the present configuration the bucket hook 1002 will have a bend or concave angle change to hook a bucket, thus facilitating ergonomics during use. The concave angle change may be located an appropriate distance away from a forward end of the hook

The bucket hook 1002 may be made of many types' shapes and sizes of materials but not limited to round, square, or rectangular bar, pipe, and rod. The bucket hook 1002 may be made of many combinations of types, shapes, and sizes of materials but not limited to only one including, bar, pipe, cast, metallic, steel, aluminum, plastics, composites, wood, and other materials. In other embodiments the pull out tool may be 3D printed out of a single material, cast or mold injected with materials known in the art to be suitable for use as a tool.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A storage rack for storing excavator buckets, the storage rack comprising:
a plurality of inclined shelves, including a top shelf and a lower shelf, each shelf affixed to a plurality of vertical posts, wherein each shelf is cantilevered over one or more of a ground surface and a lower shelf;
a plurality of vertical posts, each vertical post affixed to a plurality of shelves;
a plurality of feet, each foot affixed to one of a bottom of a shelf and a riser;
a plurality of risers, each riser affixed to a back of a shelf, the plurality of risers inclining the shelves;

2. The fork rack of claim 11, wherein each shelf defines a recess for receiving one or more buckets.

3. The fork rack of claim 11, one or more buckets can be rested on each shelf.

4. The fork rack of claim 1, further comprising a hook for detachably affixing to a forklift, the hook comprises a shaft and a concave member.

5. The fork rack of claim 1, wherein the rack is configured to be lifted and moved by a forklift.

6. The fork rack of claim 6, wherein the shelves and vertical posts are detachable from one another.

7. The excavator bucket rack of claim 1, wherein one or more of the vertical posts comprise one or more of rods, bars, angles, square tubing, rectangular tubing, round tubing, oval tubing, channels, round pipe, plates, and I-beams.

8. The excavator bucket rack of claim 1, wherein the shelves and vertical posts comprise one or more of metal, alloy, carbon steel, cast iron, aluminum, stainless steel, carbon fiber, fiberglass, resins, elastomeric materials, composites, GFRC, wood, and concrete.
